(19) United States
(12) Patent Application Publication
(10) Pub. No.: US 2007/0224380 A1
(43) Pub. Date: Sep. 27, 2007

(54) ADHESIVE SHEET AND ADHESIVE AGENT

(75) Inventors: Katsuji EBISU, Kawasaki (JP); Hiroaki DATE, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki (JP)

(21) Appl. No.: 11/690,365

(22) Filed: Mar. 23, 2007

(30) Foreign Application Priority Data
Mar. 27, 2006 (JP) 2006-085373

(51) Int. Cl. B32B 33/00; B32B 7/12; B32B 9/00

(52) U.S. Cl. 428/40.1; 428/402.2; 428/343

(57) ABSTRACT

To easily separate an adhesive sheet and an adhesive agent adhered to an adherend leaving almost no residues thereof to the adherend, the thermo-melting micro-capsule internally including a mold releasing agent dispersed within the adhesive agent layer, the adhesive agent layer is thereby easily separated from the adherend leaving almost no residues on the adherend by only heating the layer. Moreover, gaps can be formed in the adhesive agent layer through expansion of a thermo-expanding particle by adding the thermo-expanding particle to the adhesive agent layer and thereby an adhesive force of the adhesive agent layer is remarkably lowered by the mold releasing agent penetrating into such gaps.

### CROSS-REFERENCE TO RELATED APPLICATIONS

This application is based upon and claims the benefit of priority from the prior Japanese Patent Application No. 2006-085373, filed on Mar. 27, 2006, the entire contents of which are incorporated herein by reference.

### BACKGROUND OF THE INVENTION

1. Field of the Invention

The present invention relates to an adhesive sheet and an adhesive agent used for said adhesive sheet and particularly to an adhesive sheet and adhesive agent enabling easier separation from an adherend.

2. Description of the Related Art

An adhesive sheet is formed by providing an adhesive agent layer on a supporting material and such adhesive sheet is widely used as a label and in other means because of its easy usage and stronger adhesive force. However, it is difficult for an adhesive sheet to be separated from an adherend after an adhesive agent layer is adhered to the adherend. If separation is attempted too excessively, a problem arises that the adhesive sheet itself may be broken or traces of the adhesive agent may be left after separation.

In view of solving this problem, it has been proposed that thermo-expanding resin particles are previously mixed and dispersed into an adhesive agent layer of an adhesive sheet. Therefore, when the adhesive sheet is separated from the adherend, separation between the adherend and the adhesive sheet is easily accomplished after heating the adhesive sheet to expand the thermo-expanding resin particle (see, for example, Japanese Patent Application Laid-Open No. 1985-252681).

However, the above adhesive sheet does not provide a sufficient separation property because an adhesive force of the adhesive agent is not sufficiently reduced. Hence, although separation between the adherend and adhesive agent is realized with an expanding force of the thermo-expanding resin particle, the residue of the adhesive agent is left on the adherend.

Moreover, it has also been proposed that a micro-capsule internally including a mold releasing agent is previously included into an adhesive agent layer and that when the adhesive sheet is separated from the adherend, the micro-capsule is broken by pressing the adhesive sheet. After the micro-capsule is broken, the mold releasing agent is released to the adhesive agent layer in order to reduce an adhesive force of the adhesive agent(see, for example, Japanese Patent Application Laid-Open No. 1997-95650).

This adhesive sheet reduces the possibility of leaving residues of adhesive agent on the adherend because an adhesive force of the adhesive agent is reduced with operation of the mold releasing agent. Thereby, adhesive force of the adhesive agent can be remarkably lowered. However, in order to attain such an operation effect, the entire surface of the adhesive sheet must be pressed. Therefore, in the case of a large size adhesive sheet and/or an adhesive sheet adhered within narrow corners, other hard to reach areas or like situations which disable the pressing process, easier separation by pressing the adhesive sheet is difficult to realize.

### SUMMARY OF THE INVENTION

THerefore, one possible object is to provide an adhesive sheet and an adhesive agent which can realize a lower adhesive force and thereby provide easy separation from an adherend.

In particular, an example embodiment of the improved adhesive sheet includes a base material; and an adhesive agent layer formed over the base material. The adhesive agent layer includes a thermo-melting capsule with a mold release agent inside the capsule.

According to the adhesive agent, the adhesive sheet can be easily separated from an adherend by heating.

### BRIEF DESCRIPTION OF THE DRAWINGS

FIG. 1 is a schematic diagram showing an adhesive sheet in the first embodiment of the present invention;

FIGS. 2(a) and 2(b) are diagrams showing the adhesive sheet separating method in the first embodiment of the present invention;

FIG. 3 is a schematic diagram showing a modified example of the adhesive sheet in the first embodiment of the present invention;

FIG. 4 is a schematic diagram showing another modified example of the adhesive sheet in the first embodiment of the present invention;

FIG. 5 is a diagram showing results of the adhesive sheet separating test in the first embodiment of the present invention;

FIG. 6 is a schematic diagram showing the adhesive sheet of the second embodiment of the present invention;

FIGS. 7(a) and 7(b) are schematic diagrams showing a modified example of the adhesive sheet in the second embodiment of the present invention;

FIG. 8 is a diagram showing results of the adhesive sheet separating test in the second embodiment of the present invention.

### DETAILED DESCRIPTION OF THE PREFERRED EMBODIMENTS

The inventors of the present invention have found that if a micro-capsule internally including a mold releasing agent can be broken indirectly in place of direct breakage thereof, an adhered large size adhesive sheet or an adhesive sheet having hard to reach areas can be easily separated leaving almost no residues on the adherend.

### First Embodiment

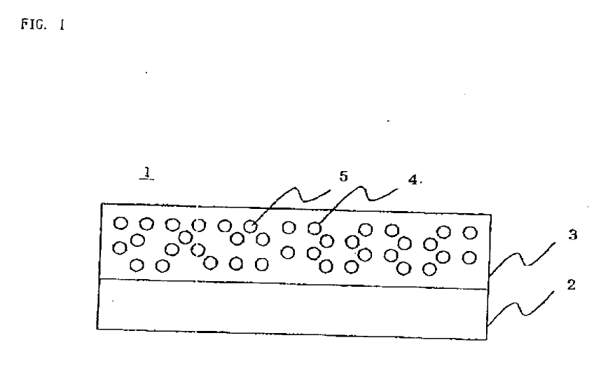

An adhesive sheet as the first embodiment of the present invention will be explained with reference to FIG. 1 to FIG. 5.

FIG. 1 is a schematic diagram showing a cross-section of an adhesive sheet of the present invention.

The adhesive sheet 1 of the embodiment shown in FIG. 1 is primarily formed of a base material 2, an adhesive agent layer 3 and a micro-capsule 4 and a mold releasing agent 5 within the micro-capsule 4.

The base material 2 is used as a supporting material of the adhesive agent layer 3 which will be explained later. For the base material, a thin planar material such as plastic film, paper, cloth, unwoven cloth, metal foil, and laminates of these materials are mainly used. Moreover, thickness of the base material 2 is generally set to 500 μm or less, particularly to the range of 5 to 250 μm but the present invention is not limited thereto. Moreover, the base material 2 is alternatively constituted as a laminated structure formed of a conductive material layer and a magnetic material layer. In the case where conductive powder and magnetic powder are included into the base material 2, this base material 2 can be inductively heated using high frequency and can also be easily heated from an isolated area.

The adhesive agent layer 3 is formed of an adhesive agent adhered to a adherend and a 180° separation adhesive force (separation rate of 300 mm/min) for a stainless steel plate is 800 g/25 mm or more. Moreover, with the effect of the mold releasing agent which will be explained later, an adhesive force is 80 g/25 mm or less. When the adhesive force is 30 g/25 mm or less, effective separation may be realized easily.

As explained above, the adhesive agent layer 3 usually has a stronger adhesive force of 800 g/25 mm or more, but the adhesive force thereof is lowered to 80 g/25 mm or less through contact with the mold releasing agent 5.

As the adhesive agent layer 3, materials obtained by combining one or more kinds of well known adhesive agents such as the materials attained by improving the creeping characteristic through orientation of the thermo-melting resins at a melting point of 200° C. or less may be utilized. For example, a rubber system, acrylic system, vinyl-alkyl-ether system, silicon system, polyester system, polyamide system, urethane system and/or stylene-diene block copolymer system may be used. Moreover, an additive agent such as a cross-linking agent, adhesive adding agent, plastic agent, filling agent and anti-aging agent or the like may also be added to the adhesive agent. Further possible adhesive agent layers are a rubber system adhesive agent including natural rubber and various kinds of synthetic rubber as the base polymer, and an acrylic system adhesive agent including as the base polymer an acrylic system polymer using one or more kinds of acrylic acid system alkyl-ester formed of ester such as acrylic acid and methacryl acid having the alkyl group with 20 carbons or less; such as, a methyl group, ethyl group, propyl group, buthyl group, amyl group, hexyl group, heptyl group, cyclohexyl group, 2-ethylhexyl group, isooctyl group, isodecyl group, lauryl group, trydecyl group, pentadecyl group, hexadecyl group, heptadecyl group, octadecyl group, nonadecyl group, and eicocyl group. In addition, in order to achieve remarkable reduction of adhesive force after the heat treatment, a polymer having the dynamic elastic modulus of 5×10⁴ dyn to 10⁶ dyn/cm² at the temperature range from room temperature to 150° C. is used as the base polymer.

The micro-capsule 4 internally includes a mold releasing agent 5 which has the function of lowering adhesive force of the adhesive agent layer 3, when it is in contact with the adhesive agent layer 3, and will be explained later. The micro-capsule, itself, is constituted from a thermo-melting material.

The micro-capsule 4 is constituted from a thermo-melting material such as vinyliden chloride.acrylonitryl copolymer, polyvinyl-alcohol, polyvinyl-buthylar, polymethyl-methacrylate, polyacrylo-nitrile, vinyliden polychloride, and polysulfon or the like. Particularly, preferable materials are a synthetic resin such as melamine.formaldehyde resin and isocyanate resin which when used as the micro-capsule 4, are very suitable because of their water-proof characteristic and anti-solvent properties. Moreover, the preferred melting point of the micro-capsule is in a range from 60° C. to 150° C. The reason is that when the melting point of micro-capsule is under 60° C., a part of the micro-capsule 4 is likely to melt, for example, under room temperature, even if the heat treatment is not conducted. Moreover, when the melting point of micro-capsule 4 is 150° C. or higher, heating up to 200° C. or higher is required for thermal solution of the micro-capsule 4. Accordingly, this higher temperature range is not suitable because an ordinary adherend will likely thermally deteriorate at such temperatures. Here, the melting point means a melting peak temperature measured with a Differential Scanning Calorimeter (DSC) under the temperature rising rate of 10±1° C./min conforming to the JIS K7121.

Moreover, the micro-capsule 4 internally including the mold releasing agent 5 explained later may be manufactured with well known methods; such as, the coacervation method, interface polymerization method and in-situ polymerization method or the like.

The desirable average particle size of the micro-capsule 4 is in a range from 1 to 50 μm. The reason is that if the average particle size of the micro-capsule 4 is 1 μm or less, the amount of content of the mold releasing agent 5 internally included in one micro-capsule 4 maybe insufficient and an adhesive force of the adhesive agent layer 3 may not be sufficiently reduced. Moreover, when the average particle size of the micro-capsule 4 is 50 μm or more, the micro-capsule 4, which has no adhesive force by itself, will occupy the greater part of the volume of the adhesive agent layer 3 and thereby the adhesive agent layer 3 may no longer have sufficient adhesive force.

The mold releasing agent 5 is usually included internally in the micro-capsule 4. However, when the micro-capsule 4 thermally melts, the mold releasing agent 5 is released into the adhesive agent layer 3, lowering the adhesive force of the adhesive agent layer 3, for example, to 80 g/25 mm or less.

As the mold releasing agent 5, higher fatty acid, higher fatty acid dielectric material, organo-polycyloxane compound, wax, higher alcohol, mineral oil, animal oil, plant oil, silicon oil or a mixture thereof may be used. Moreover, an oxidation preventing agent and an ultraviolet absorbing agent may also be included thereto as required. Here, lower viscosity is desirable for the mold releasing agent 5. The reason is that if viscosity of mold releasing agent 5 is too high, even when the mold releasing agent 5 is released into the adhesive agent layer 3, it cannot be spread sufficiently in the adhesive-agent layer 3 and thereby the contact area with the adhesive agent layer 3 is reduced and the strength of the adhesive agent of the adhesive agent layer 3 cannot be sufficiently lowered. Moreover, it is desirable that the mold releasing agent 5 is provided within the range of 1 to 20 wt % in the weight-percentage of the adhesive agent layer 3 for the adhesive sheet 1 to have sufficient adhesive force and the easy separation characteristic.

Next, the method for separating the adhesive sheet 1 adhered to the adherend will be explained below.

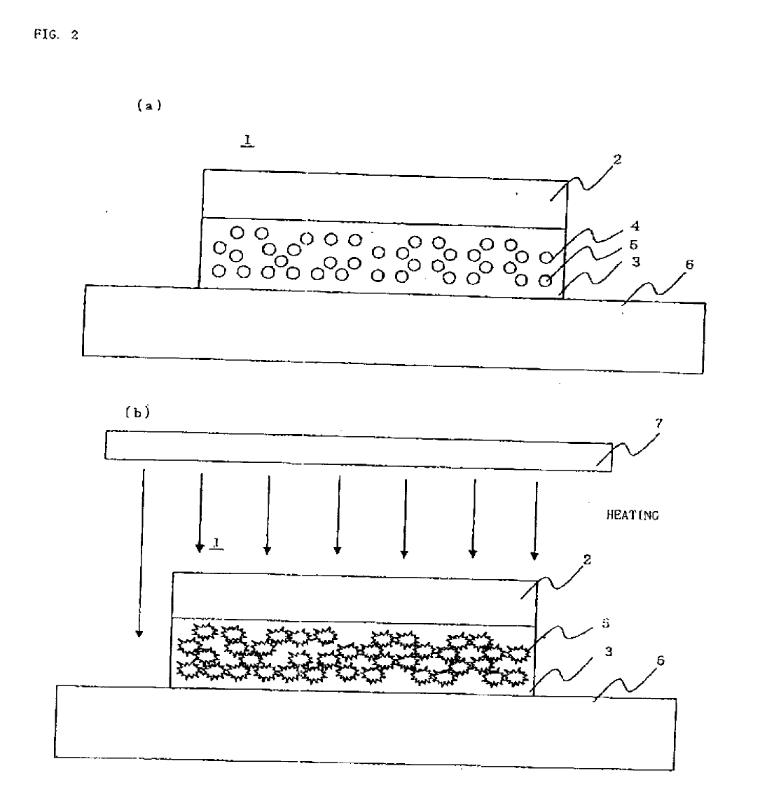

FIG. 2 is a diagram showing a method for separating an adhesive sheet 1 with the first embodiment of the present invention.

As shown in FIG. 2(a), the adhesive sheet 1 is adhered to the adherend 6. In this case, the adhesive force is 800 g/25 mm or more.

Next, as shown in FIG. 2(b), when the adhesive sheet 1 is heated with a heating means 7, the micro-capsule 4 melts and the mold releasing agent 5 internally included in the micro-capsule 4 is released into the adhesive agent layer 3. Therefore, the adhesive force of the adhesive agent layer 3 is remarkably lowered and therefore the adhesive sheet 1 can be separated easily from the adherend 5. For example, the adhesive force becomes 80 g/25 mm or less. Here, the heating means 7 is, for example, a hot plate which is set to 100 to 250° C. and applied to the adhesive sheet 1 for 1 to 90 seconds. In this embodiment, the heating means 7 has been explained as the hot plate but it is not limited thereto and any type of heating means which can heat the adhesive sheet 1 may be used. For example, as explained above, the heating means may be formed of a material which can generate a high frequency by previously including a magnetic material into the base material 2.

As explained above, in this embodiment, the mold releasing agent 5 for lowering adhesive force of the adhesive agent layer 3 is internally included into the thermo-melting micro-capsule 4. Accordingly, even when a strong adhesive force is assumed, the adhesive sheet 1 can be easily separated from the adherend without leaving any residues thereto by only thoroughly heating the adhesive sheet 1.

FIG. 3 is a diagram showing a modified example of the first embodiment.

FIG. 3 shows an example in which an adhesive agent layer 3-1, like that of FIG. 1, is formed to the surface other than that on which the adhesive agent layer 3 of the base material 2 shown in FIG. 1 is formed and a label 8 is formed in contact with the adhesive agent layer 3-1.

The label 8 is formed of a sheet of paper or plastic and maybe collected for re-use.

When the adhesive sheet 1 is formed as shown in FIG. 3, adhesive forces of both the adhesive agent layer 3-1 bonded to the label 8 and the adhesive agent layer 3 bonded to the adherend can be reduced only by heating once the adhesive sheet 1 is adhered to the adherend. Accordingly, not only separation from the adherend can be easily obtained but also separation from the label 8 can be done easily, making for easier collection of the label 8. Moreover, since separation from both adherend and label 8 can be conducted easily with only a single step heating process, the separation work can be executed more effectively.

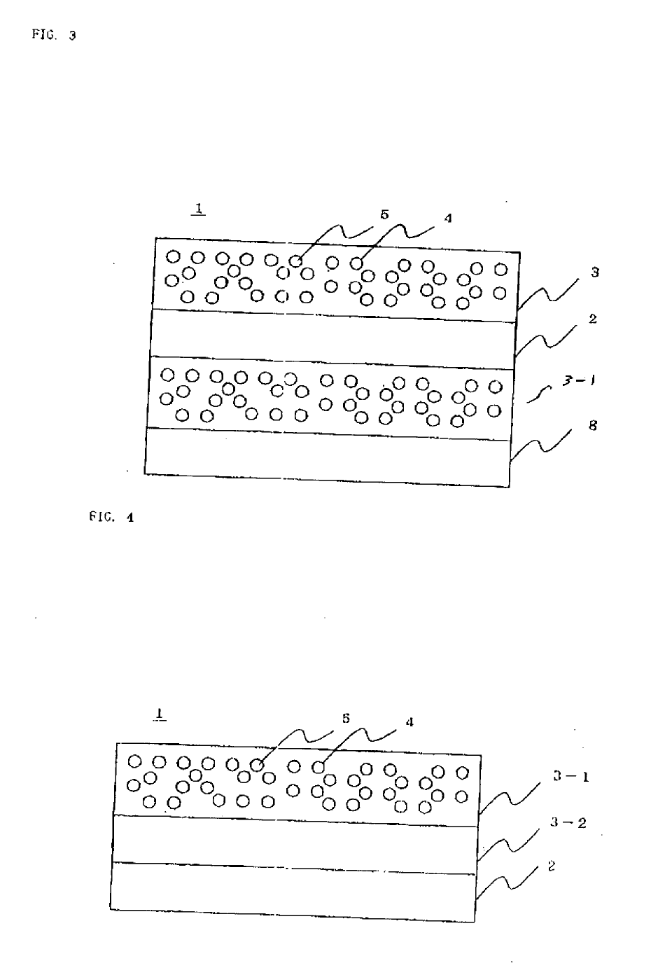

FIG. 4 is an diagram showing another modified example of the first embodiment.

FIG. 4 shows an example where the adhesive agent layer 3 shown in FIG. 1 is formed of a plurality of layers comprising a first adhesive agent layer 3-1 including the micro-capsule 4 internally including the mold releasing agent 5 and a second adhesive agent layer 3-2 which is formed only of the adhesive agent layer not including the micro-capsule 4.

When the adhesive sheet is formed as shown in FIG. 4, the micro-capsule 4 is only in the first adhesive agent layer 3-1 at the outermost surface to the adherend. Therefore, adhesive force is reduced in the part near the adherend and the velocity of the separation can be increased. Moreover, residues remaining on the adhesive agent layer for the adherend can be greatly reduced. When adhesive force is taken into account, the preferred thickness of the first adhesive agent layer 3-1 is set in a range from 5 μm to 20 μm.

Next, the manufacturing of an adhesive sheet of this embodiment will be explained and the results of investigations of adhesive force of the adhesive sheet are explained below.

(First Experiment)

Fluorine denaturated silicon oil (FS1265 1000CS, Hanwa Industries, Co., Ltd.) of 80 weight part is added to 180 weight part of 4% aqueous solution of an ethylene-maleic anhydride copolymer in which pH is adjusted to 6.0 and the mixture is then emulsificated using homogenizer. The emulsificated solution is then heated to 60° C.

Next, melamine of 20 weight part is added to 40% formaldehyde aqueous solution of 40 weight part for reaction thereof for 15 minutes at 60° C. The obtained prepolymer aqueous solution is added into the emaulsificated solution. While the solution is being stirred, hydrochloric acid of 0.1N is added to adjusted pH to 5.3. The solution is then heated to 80° C. and is then stirred for an hour at the stirring rate of 10000 rpm. Subsequently, hydrochloric acid of 0.2N is added to lower pH to 3.5. Subsequently, the solution is stirred for three hours and then cooled. Thereby, the micro-capsule dispersed solution internally including the mold releasing agent with an average particle size of 10 μm is obtained.

The melting point of this micro-capsule is about 100° C. as a result of measurement using the DSC.

Next, this micro-capsule dispersed solution is filtered and pressed. Thereafter, the solution is dried under an air-flowing condition to manufacture the micro-capsule powder.

Next, the micro-capsule powder of 30 weight part is mixed into an acrylic system adhesive agent of 100 weight part, this agent is coated to a single surface of a polyester film in the thickness of 100 μm in order to form the adhesive agent layer including the micro-capsule in the thickness of 50 μm.

A weight percentage of the mold releasing agent for the adhesive agent layer is set to 10 wt %.

The adhesive sheet (first experiment) has been manufactured as explained above.

(Second Experiment)

Fluorine denaturated silicon oil (.FS1265 1000CS, Hanwa Industries, Co., Ltd.) of 80 weight part is added to 180 weight part of 4% aqueous solution of an ethylene-maleic andydride copolymer in which pH is adjusted to 6.0 and the mixture is then emulsificated using homogenizer. The emulsificated solution is heated to 50° C.

Next, melamine of 20 weight part is added to 40% formaldehyde aqueous solution of 40 weight part for reaction thereof at 10 minutes at 50° C. The obtained prepolymer aqueous solution is added into the emaulsificated solution. While the solution is being stirred, hydrochloric acid of 0.1N is added to adjust pH to 5.3. The solution is then heated to 70° C. and is then stirred for 0.5 hour at the stirring rate of 10000 rpm. Subsequently, hydrochloric acid of 0.2N is added to lower pH to 3.5. Subsequently, the solution is further stirred for three hours and then cooled. Thereby, the micro-capsule dispersed solution internally including the mold releasing agent with an average particle size of 10 μm is obtained.

The melting point of this micro-capsule is about 55° C. as a result of measurement using the DSC.

Next, this micro-capsule dispersed solution is filtered and pressed. Thereafter, the solution is dried under an air-flowing condition to manufacture the micro-capsule powder.

Next, the micro-capsule powder of 30 weight part is mixed into an acrylic system adhesive agent of 100 weight part, this agent is coated to a single surface of a polyester film in the thickness of 100 μm in order to form the adhesive agent layer including the micro-capsule in the thickness of 50 μm.

A weight percentage of the mold releasing agent for the adhesive agent layer is set to 10 wt %.

The adhesive sheet (second experiment) is manufactured as explained above.

(Third Experiment)

Fluorine denaturated silicon oil (FS1265 1000CS, Hanwa Industries, Co., Ltd.) of 80 weight part is added to 180 weight part of 4% aqueous solution of ethylene-maleic andydride copolymer in which pH is adjusted to 6.0 and the mixture is then emulsificated using homogenizer. The emulsificated solution is heated to 60° C.

Next, melamine of 20 weight part is added to 40% formaldehyde aqueous solution of 40 weight part for reaction thereof for 20 minutes at 60° C. The obtained prepolymer aqueous solution is added into the emaulsificated solution. While the solution is being stirred, hydrochloric acid of 0.1N is added to adjust pH to 5.3. The solution is then heated to 85° C. and is then stirred for 1.5 hours at the stirring rate of 1000 rpm. Subsequently, hydrochloric acid of 0.2N is added to lower pH to 3.5. Subsequently, the solution is stirred for three hours and then cooled. Thereby, the micro-capsule dispersed solution internally including the mold releasing agent at an average particle size of 10 μm is obtained.

The melting point of this micro-capsule is about 155° C. as a result of measurement using the DSC.

Next, this micro-capsule dispersed solution is filtered and pressed. Thereafter, the solution is dried under an air-flowing condition to manufacture the micro-capsule powder.

Next, the micro-capsule powder of 30 weight part is mixed into an acrylic system adhesive agent of 100 weight part, this agent is coated to a single surface of a polyester film in the thickness of 100 μm in order to form the adhesive agent layer including the micro-capsule in the thickness of 50 μm.

A weight percentage of the mold releasing agent for the adhesive agent layer is set to 10 wt %.

The adhesive sheet (third experiment) is manufactured as explained above.

(Fourth Experiment)

The adhesive sheet (fourth experiment) is manufactured to set the weight percentage for the adhesive agent layer of the mold releasing agent to 0.5 wt % by controlling a mixing ratio between the micro-capsule powder and the acrylic system adhesive agent in the first experiment.

(Fifth Experiment)

The adhesive sheet (fifth experiment) is manufactured to set the weight percentage for the adhesive agent layer of the mold releasing agent to 21 wt % by controlling a mixing ratio between the micro-capsule powder and the acrylic system adhesive agent in the first experiment.

(Six Experiment)

The adhesive sheet (sixth experiment) is manufactured to set the average particle size of the micro-capsule to 0.5 μm by stirring the solution at the stirring velocity of 30000 rpm for an hour in the first experiment.

(Seventh Experiment)

The adhesive sheet (seventh experiment) is manufactured to set the average particle size of the micro-capsule to 55 μm by stirring the solution at the stirring velocity of 2000 rpm for an hour in the first experiment.

(Eighth Experiment)

The adhesive sheet (eighth experiment) is manufactured by forming a second adhesive agent layer at a thickness of 40 μm through coating an acrylic system adhesive agent not including the micro-capsule on the base material formed of a polyester film at a thickness of 100 μm and by forming the first adhesive agent layer at a thickness of 30 μm through coating of the mixed adhesive agent of the micro-capsule powder manufactured in the first experiment and the acrylic system adhesive agent of the second adhesive agent layer.

A 180° separation experiment has been conducted under the conditions explained below using the adhesive sheet manufactured as indicated in the first to eighth experiments explained above.
Adherend: Stainless steel plate (SUS 304, Surface is finished By BA process;
Temperature: 25° C. (room temperature), 110° C. (heated for 10 minutes), 160° C. (heated for 10 minutes);
Atmospheric resistance: Left under atmospheric condition for 30 days.

In the separation test after heat treatment, under the temperature of 110° C. and 160° C., the respective separation tests have been conducted after heat treatment for 10 minutes.

Results of the separation test of the adhesive sheet for the first to eighth experiments are shown in FIG. 5.

As shown in FIG. 5, the adhesive sheet in the first experiment has higher adhesive force under room temperature and shows higher separation property after heat treatment.

Moreover, in the second experiment, in the case where the adhesive sheet is left, after adhesion, for 30 days at room temperature, the adhesive force thereof is remarkably lowered in comparison with the first experiment. The assumed reason is that since the melting point of the micro-capsule is as low as 55° C., the mold releasing agent diffused out from the micro-capsule as the time passes.

In the third experiment, the adhesive force is never lowered even after the heat treatment. The assumed reason is that since the melting point of the micro-capsule is as high as 155° C., a result similar to that of the first experiment is not obtained by increasing the heating temperature.

In the fourth experiment, the adhesive force is never lowered even after the heat treatment. The assumed reason is that amount of the mold releasing agent for the adhesive agent layer is rather small and therefore the adhesive force of the adhesive agent layer cannot be lowered sufficiently.

In the fifth experiment, a high adhesive force is attained at room temperature and a high separation property can also be attained through heat treatment. However, an excessive amount of the mold releasing agent is used and the adherend has been contaminated with this mold releasing agent.

In the sixth experiment, the adhesive force is never lowered even after the heat treatment. The assumed reason is that the particle size of the micro-capsule is too small, namely the amount of the mold releasing agent for the adhesive agent layer is insufficient and thereby the adhesive force of the adhesive agent layer cannot be lowered sufficiently.

In the seventh experiment, higher separation property is attained after the heat treatment in comparison with the first experiment, but the adhesive force under the room temperature is insufficient.

In the eighth experiment, it is apparent that higher adhesive force is attained under room temperature and higher separation property is attained through heat treatment.

### Second Embodiment

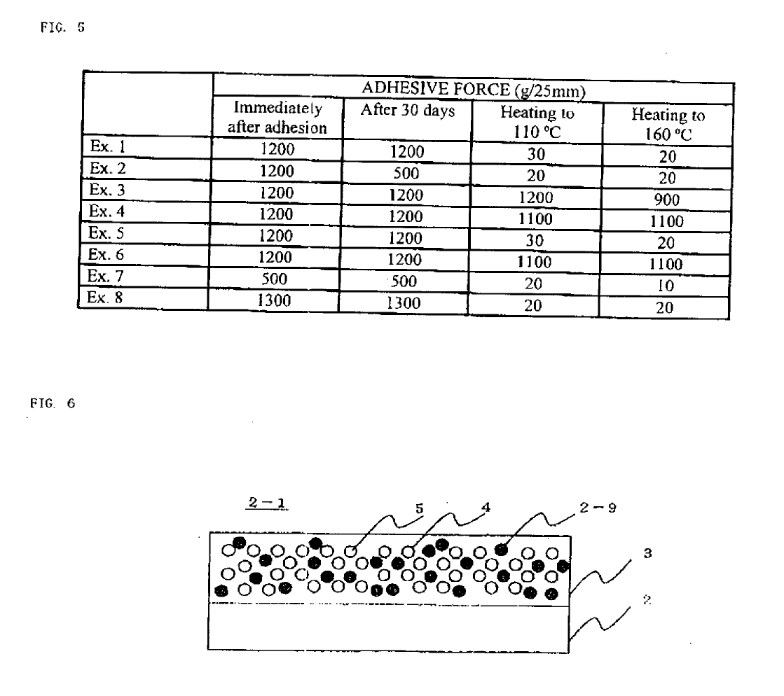

Next, the adhesive sheet based on the second embodiment of the present invention will be explained with reference to FIG. 6 to FIG. 8.

In this second embodiment, not only the micro-capsule internally including the mold releasing agent in the adhesive agent layer of the adhesive sheet of the first embodiment explained previously is included but also the adhesive sheet includes a thermo-expanding particle as explained below.

FIG. 6 is a schematic diagram showing the cross-section of the adhesive sheet of the second embodiment of the present invention.

The adhesive sheet 2-1 in this embodiment shown in FIG. 6 is mainly constituted from a base material 2, micro-capsule 4 internally including the mold releasing agent 5, and thermo-expanding particle 2-9. The elements like that in the first embodiment are denoted with like reference numerals.

The adhesive sheet 2-1 in this embodiment is different from the adhesive sheet 1 of the first embodiment in the point that thermo-expanding particle 2-9 is dispersed within the adhesive agent layer 3.

The thermo-expanding particle 2-9 is dispersed within the adhesive agent layer 3 together with the micro-capsule 4. This thermo-expanding particle 2-9 has the property that it is expanded in volume up to 5 to 10 times through the heat treatment and thereafter breaks down.

In the second embodiment, the adhesive agent layer 3 is constituted to include the thermo-expanding particle 2-9. Therefore, when the adhesive sheet 2-1 bonded to the adherend is heated with the heating means, the thermo-expanding particle 2-9 expands through the heat treatment and gaps are generated within the adhesive agent layer 3 due to the pressing force generated by expansion. When the mold releasing agent 5 released through the melting of the micro-capsule 4 enters the gap, the adhesive force of the adhesive agent layer 3 is lowered. Meanwhile, the adjacent micro-capsules 4 are pressed against each other through the thermal expansion, and breakdown of the micro-capsules 4 is also accelerated with this pressing force.

The thermo-expanding particle 2-9, are attained by internally including a substance which is easily gasificated to thereby exhibit the thermal expanding property. Such substances as isobutene, propane, and pentane or the like are utilized by placement into a shell type substance through coacervation method, interface polymerization can be used. As the shell type substance, thermo-melting substances, for example, such as vinylidene chloride.acrylonitril copolymer, polyvinyl-alcohol, polyvinyl-buthylar, polymethyl-methacrylate, polyacrylotril, vinyldene polychloride and polysulfon or the like and similar substances which may be broken by thermal expansion may be used. As the thermo-expanding particle 2-9, for example, a microsphere manufactured by Matsumoto Grease Co., Ltd. may be used.

Moreover, it is more preferable to use, as the adhesive agent layer 3, the material which can form gaps with a pressing force due to expansion of the thermo-expanding particle 2-9.

Moreover, it is also preferable to use the thermo-expanding particle 2-9 which starts thermal expansion within the temperature range of 80 to 200° C. If the thermo-expanding particle 2-9 starts thermal expansion under the temperature of 80° C. or lower, a part of the particle 2-9 will likely start thermal expansion without any heat treatment, for example, even under room temperature and thereby the adhesive force of the adhesive agent layer 3 may be untimely lowered. Moreover, a particle 2-9, which starts thermal expansion at the temperature of 200° C. or higher, is not desirable because an ordinary adherend will likely be deteriorated thermally.

In addition, it is desirable in order for the adhesive sheet 2-1 to have sufficient adhesive force and attain the required separation property that the thermal-expanding particle 2-9 has a weight percentage in the range of 1 to 20 wt % for the adhesive agent layer 3.

Moreover, the desirable average particle size of the thermo-expanding particle 2-9 should be in a range from 1 to 50 μm. When the average particle size of the thermo-expanding particle 2-9 is 1 μm or less, the gap formed by the thermo-expanding particle 2-9 when thermally expanded to widen the adhesive agent layer 3 with pressure is too small and therefore a sufficient effect cannot be obtained. Moreover, when the average particle size of the thermo-expanding particle 2-9 is 50 μm or more, the thermo-expanding particle 2-9 having no adhesive force by itself occupies the greater part of the volume of adhesive agent layer, and therefore the adhesive agent layer 3 cannot have sufficient adhesive force.

As explained above, the adhesive sheet in this second embodiment disperses the thermo-expanding particle in the adhesive agent layer of the adhesive sheet explained in the first embodiment. Therefore, the adhesive agent layer is widened with pressure due to expansion of the thermo-expanding particle and thereby gaps are generated in the adhesive agent layer. Here, the mold releasing agent released from the micro-capsules diffuses into such gaps and the adhesive force of the adhesive agent layer is remarkably lowered.

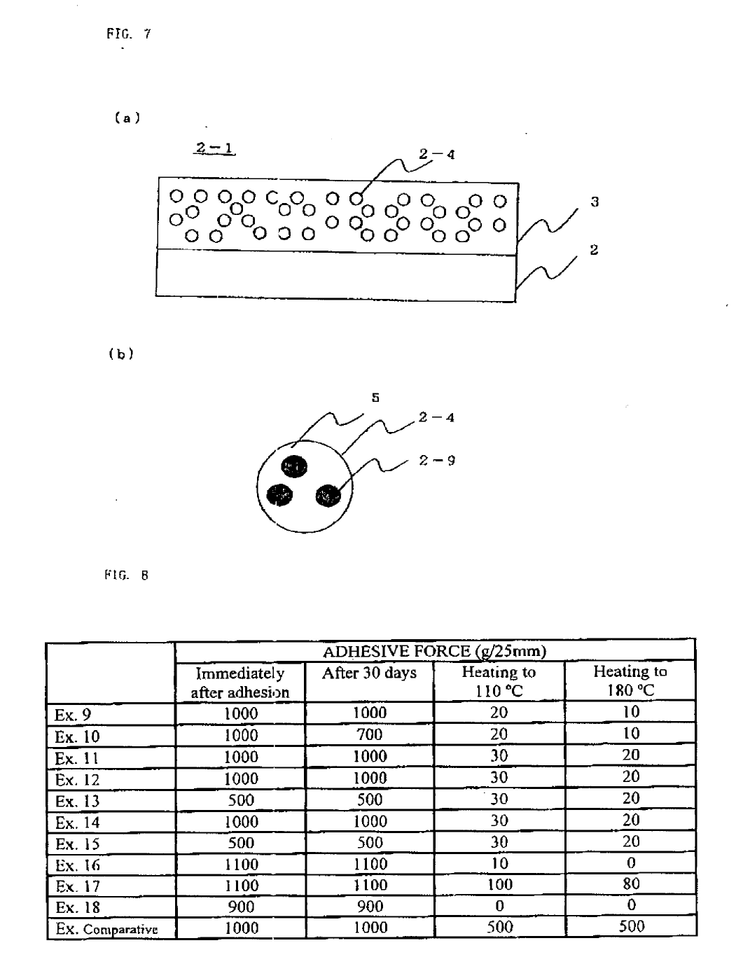

FIG. 7 is a diagram showing a modified example of the adhesive sheet of the second embodiment.

The adhesive sheet 2-1 shown in FIG. 7 is constituted, as shown in FIG. 7(b), in the manner that the micro-capsule 2-4 internally includes the thermo-expanding particle 2-9 and the mold releasing agent 5.

When the micro-capsule 2-4 is constituted as explained above, the micro-capsule 2-4 can surely be broken from the internal side with operation of the thermo-expanding particle 2-9 which is expanded through the heat treatment. Moreover, the thermo-expanding particle 2-9 also works to push the mold releasing agent 5 out of the micro-capsule 2-4 in order to accelerate release of the mold releasing agent 5 and also to accelerate spread thereof to the adhesive agent layer 3.

Moreover, it is more preferable to raise a ratio of the mold releasing agent 5 more than the thermo-expanding particle 2-9 within the micro-capsule 2-4 because the adhesive force of the adhesive agent layer 3 is thereby lowered.

Moreover, it is also acceptable that the thermo-expanding particle 2-9 is dispersed for arrangement within the adhesive agent layer 3 as shown in FIG. 6, and the thermo-expanding particle 2-9 and mold releasing agent 5 are internally included in the micro-capsule 2-4 as shown in FIG. 7. With the structure explained above, gaps are formed in the adhesive agent layer 3 with the thermo-expanding particle 2-9 arranged in the adhesive agent layer 3 and breakdown of micro-capsule 2-4, acceleration of release of the mold releasing agent 5 and spread of mold releasing agent 5 into the adhesive agent layer 3 are realized mainly with the thermo-expanding particle 2-9 in the micro-capsule 2-4.

As explained above, since the adhesive sheet in this second embodiment arranges the thermo-expanding particle into the adhesive agent layer and micro-capsule, the dispersion property of the mold releasing agent into the adhesive agent layer under heat treatment can be enhanced.

Next, the results of investigations on the adhesive force by manufacturing the adhesive sheet explained in this second embodiment will be explained below.

(Ninth Experiment)

Ion exchange water of 600 g, sodium chloride of 150 g, condensed substance of adipic acid-diethanol-amine of 1.5 g and 20% aqueous solution of colloidal silica of 40 g are mixed and pH of this mixed solution is adjusted to 3.7 to 4.1 with the addition of sulfuric acid. The obtained solution is used as the water phase.

Next, acrylnitril of 180 g, methacrylonitril of 105 g, methyl-metacryl acid of 15 g, methacryl-acid-ethylene gricol of 1.5 g, polyoxyethylene-nonylphenyl-ethe-acrylate of 2.0 g, isopentane of 75 g and azobith-isobuthyl-nitril of 1 g are mixed, stirred, and dissolved. The obtained solution is used as the oil phase.

Next, the water phase and oil phase manufactured as explained above are then mixed and stirred for five minutes with a TK homo-mixer at the stirring velocity of 20000 rpm in order to obtain the suspension.

Moreover, this suspension is transferred to a 1.5 L pressure reacting apparatus for the purpose of nitrogen replacement. Thereafter, the suspension is stirred for 15 hours at 70° C. for reaction thereof.

The obtained reactant is filtered and dried to obtain the thermo-expanding particle with an average particle size of 10 μm.

Next, the thermo-expanding particle is mixed with the micro-capsule powder and acrylic system adhesive agent manufactured in the same processes as the first experiment of the first embodiment in order to manufacture the adhesive sheet (ninth experiment). The thermo-expanding particle has the expansion starting temperature of 100° C. and is included at the weight percentage of 10 wt % for the adhesive agent layer.

(Tenth Experiment)

The adhesive sheet (tenth experiment) has been manufactured with the processes similar to that of the ninth experiment, except for the process that the expansion starting temperature of the thermo-expanding particle manufactured in the ninth experiment is adjusted to 75° C.

(Eleventh Experiment)

The adhesive sheet (eleventh experiment) has been manufactured with the processes similar to that of the ninth experiment, except for the process that the expansion starting temperature of the thermo-expanding particle manufactured in the ninth experiment is adjusted to 210° C.

(Twelfth Experiment)

The adhesive sheet (twelfth experiment) has been manufactured with the processes similar to that of the ninth experiment, except for the process that the thermo-expanding particle manufactured in the ninth experiment is adjusted to 0.5 wt % of the adhesive agent layer.

(Thirteenth Experiment)

The adhesive sheet (thirteenth experiment) has been manufactured with the processes similar to that of the ninth experiment, except for the process that the thermo-expanding particle manufactured in the ninth experiment is adjusted to 21 wt % of the adhesive agent layer.

(Fourteenth Experiment)

The adhesive sheet (fourteenth experiment) has been manufactured with the processes similar to that of the ninth experiment, except for the process that the average particle size of the thermo-expanding particle manufactured in the ninth experiment is adjusted to 0.5 μm.

(Fifteenth Experiment)

The adhesive sheet (fifteenth experiment) has been manufactured with the processes similar to that of the ninth experiment, except for the process that the average particle size of the thermo-expanding particle manufactured in the ninth experiment is adjusted to 55 μm.

(Sixteenth Experiment)

Fluorine denaturated silicon oil (FS 1265 1000CS, Hanwa Industries, Co., Ltd.) of 80 weight part is added to 180 weight part of 4% aqueous solution of ethylene-maleic anhydride copolymer in which pH is adjusted to 6.0 and the mixture is then emulsificated using a homogenizer. Thereafter, the thermo-expanding particle of 100 weight part manufactured in the ninth embodiment is mixed and dispersed. The emulsificated solution is heated to 60° C.

In addition, melamine of 20 weight part is added to the 40% formaldehyde aqueous solution of 40 weight part for reaction thereof for 15 minutes at 60° C. The obtained prepolymer aqueous solution is dropped into the emaulsificated solution. While the solution is being stirred, hydrochloric acid of 0.1N is added to adjust pH to 5.3. The solution is then heated to 80° C. and is then stirred for an hour. Subsequently, hydrochloric acid of 0.2N is added to lower pH to 3.5. Subsequently, the solution is further stirred for three hours and then cooled. Thereby, the micro-capsule dispersed solution including the thermo-expanding particle and the mold releasing agent with an average particle size of 10 μm is obtained.

Melting point of a shell material of this micro-capsule has been measured as 100° C. with the DSC.

Next, this dispersed solution is filtered and pressed and is dried under the air flowing condition. Thereby, the micro-capsule powder including thermo-expanding particle and mold releasing agent is obtained.

Thereby, the adhesive sheet (sixteenth experiment) is manufactured with the processes similar to that of the first experiment in the first embodiment.

(Seventeenth Experiment)

The adhesive sheet (seventeenth experiment) is manufactured with a process similar to that of the sixteenth experiment, except for that the thermo-expanding particle in the micro-capsule powder in the sixteenth experiment is adjusted in terms of weight percentage to 1.1 of the mold releasing agent.

(Eighteenth Experiment)

The adhesive sheet (eighteenth experiment) including the micro-capsule internally including the thermo-expanding particle and mold releasing agent and the adhesive agent layer dispersing the thermo-expanding particle is manufactured with the processes similar to that of the ninth experiment using the micro-capsule powder of the sixteenth experiment.

(Comparison Example)

The adhesive sheet (comparison example) corresponding to the adhesive sheet of the prior art where only the thermo-expanding particle of the ninth experiment is included into the adhesive agent layer has been manufactured without mixture of the micro-capsule powder of the first experiment in the first embodiment.

A 180° separation experiment has been conducted under the condition similar to that in the first embodiment, using the adhesive sheet which has been manufactured as shown in the ninth experiment to eighteenth experiment and in the comparison example explained above.

Results of separation tests of the adhesive sheets of this embodiment are shown in FIG. 8.

As shown in FIG. 8, the adhesive force after the heat treatment can be lowered in the ninth experiment, although the adhesive force under room temperature is lowered, in comparison with that in the first experiment.

In the tenth experiment, when the adhesive sheet is left for 30 days after adhesive deposition at room temperature, the adhesive force of the sheet is remarkably lowered in comparison with the ninth experiment. The assumed reason is that since the thermal expansion starting temperature of the thermo-expanding particle is as low as 75° C., the thermo-expanding particle naturally expands with the passage of time, and thereby the adhesive force is lowered.

In the eleventh experiment, the adhesive force after heat treatment is similar to that in the first experiment of the first embodiment. The assumed reason is that since the thermal expansion starting temperature of the thermo-expanding particle is as high as 210° C., when the heating temperature is increased, the results similar to that in the ninth experiment can be obtained.

In the twelfth experiment, the mixing rate of the thermo-expanding particle is low and the adhesive force similar to that in the first experiment of the first embodiment is obtained even after heat treatment.

In the thirteenth experiment, the mixing rate of the thermo-expanding particle is high and the adhesive force of the adhesive agent layer at room temperature is lowered.

In the fourteenth experiment, the average particle size of the thermo-expanding particle is too small, and the adhesive force after heat treatment is similar to that in the first experiment of the first embodiment.

In the fifteenth experiment, the average particle size of the thermo-expanding particle is too large, and the adhesive force of the adhesive agent layer under the room temperature is lowered.

In the sixteenth experiment, the adhesive force under room temperature is high and the adhesive force of the adhesive agent layer after heat treatment is extremely lower.

In the seventeenth experiment, the rate of the mold releasing agent is small and the adhesive force cannot be lowered sufficiently after heat treatment.

In the eighteenth experiment, the adhesive force under room temperature is lowered but the adhesive force after heat treatment is extremely lower.

In the comparison example, the adhesive sheet corresponds to that of the related art for realizing separation with a thermal expanding force of the thermo-expanding particle and the adhesive force thereof cannot be lowered sufficiently even after the heat treatment.

The invention as described above is specifically directed to the noted embodiments. However, the present invention is not restricted to the embodiments. One of skill in the art may modify the described embodiments and still practice the invention as claimed below.

What is claimed is:

1. An adhesive sheet comprising:
a base material;
an adhesive agent layer formed over the base material;
wherein the adhesive agent layer includes at least one thermo-melting micro-capsule with a mold releasing agent inside the thermo-melting micro-capsule.

2. The adhesive sheet according to claim 1, wherein the mold releasing agent is mixed in a range of 1 to 20 wt % of the adhesive layer.

3. The adhesive sheet according to claim 1, wherein the base material includes a conductive material or a magnetic material.

4. The adhesive sheet according to claim 1, wherein the thermo-melting micro-capsule melts within the temperature range from 60 to 150° C.

5. The adhesive sheet according to claim 1, wherein the thermo-melting micro-capsule has an average particle size in the range from 1 to 50 μm.

6. The adhesive sheet according to claim 1, wherein the adhesive agent layer is formed of a first layer including the thermo-melting micro-capsule with the mold releasing agent inside the micro-capsule and a second layer formed of only an adhesive agent.

7. The adhesive sheet according to claim 6, wherein the first layer is provided at the surface opposing to an adherend.

8. The adhesive sheet according to claim 1, wherein the adhesive agent layer includes a thermo-expanding particle.

9. The adhesive sheet according to claim 1, wherein the thermo-melting micro-capsule includes a thermo-expanding particle inside said micro-capsule.

10. The adhesive sheet according to claim 9, wherein the adhesive agent layer further includes the thermo-expanding particle outside said micro-capsule.

11. The adhesive sheet according to claim 8, wherein the thermo-expanding particle starts thermal expansion in a temperature range from 80 to 200° C.

12. An adhesive agent comprising:
a thermo-melting micro-capsule internally including a mold releasing agent.

13. The adhesive agent according to claim 12, wherein the adhesive agent includes a thermo-expanding particle.

14. The adhesive agent according to claim 12, wherein the thermo-melting micro-capsule includes the thermo-expanding particle inside said micro-capsule.

15. The adhesive agent according to claim 14, wherein the adhesive agent further includes the thermo-expanding particle outside said micro-capsule.

16. The adhesive sheet according to claim 1, wherein the material of the thermo melting micro-capsule is at least one of the group consisting of vinyliden chloride.acrylonitryl copolymer, polyvinyl-alcohol, polyvinyl-buthylar, polymethyl-methacrylate, polyacrylo-nitrile, vinyliden polychloride, and polysulfon, melamine.formaldehyde resin and isocyanate resin.

17. The adhesive agent according to claim 12, wherein the material of the thermo melting micro-capsule is at least one of the group consisting of vinyliden chloride.acrylonitryl copolymer, polyvinyl-alcohol, polyvinyl-buthylar, polymethyl-methacrylate, polyacrylo-nitrile, vinyliden polychloride, and polysulfon, melamine.formaldehyde resin and isocyanate resin.

18. The adhesive sheet according to claim 1 wherein the material of the adhesive agent layer comprises at least one member selected from the group consisting of: a rubber system, acrylic system, vinyl-alkyl-ether system, silicon system, polyester system, polyamide system, urethane system and stylene-diene block copolymer system.

19. The adhesive sheet according to claim 1 wherein the material of the adhesive agent layer is at least one selected from the group consisting of:
a rubber system adhesive agent including natural rubber and synthetic rubber as the base polymer, and an acrylic system adhesive agent including as the base polymer an acrylic system polymer using one or more acrylic acid systems.

20. The adhesive agent according to claim 19 wherein the material of the adhesive agent layer contains an additive agent of at least one of the group consisting of: a cross-linking agent, adhesive adding agent, plastic agent, filling agent and anti-aging agent.
